(19) United States
(12) Patent Application Publication
(10) Pub. No.: US 2007/0282619 A1
(43) Pub. Date: Dec. 6, 2007

(54) Conjoint method for making decisions regarding patent assertion and patent licensing

(75) Inventor: John Joseph Cheek, Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/443,279

(22) Filed: May 31, 2006

(51) Int. Cl. G06Q 10/00; G06Q 30/00

(52) U.S. Cl. 705/1

(57) ABSTRACT

A conjoint method for making patent assertion and patent licensing decisions is disclosed. The method includes identifying at least one feature protected by patents within a patent portfolio. The method also includes generalizing the at least one feature into one or more corresponding attributes and administering a conjoint survey based on the corresponding attributes. Preference data is obtained from results of the conjoint survey. The preference data is used to determine whether to take action with respect to a patent in the portfolio.

### TECHNICAL FIELD

This disclosure relates generally to a conjoint method for making decisions, and more particularly, to a conjoint method for making decisions regarding patent assertion and patent licensing.

### BACKGROUND

A patent provides a patentee or patent owner with a right to exclude others from making, using, selling or offering to sell products or services protected by the patent. Patents may help sustain a competitive advantage in the marketplace. For example, a patent may be used to preclude others from offering a protected feature of a product or service that provides utility to purchasers, thereby making the patentee's product or service more attractive to customers than competing products or processes. In another example, a protected feature of a patented product or service may allow the patentee or patent owner to make or offer the product or service at a lower cost than competitors. In such cases, products or services offered by competitors may have similar utility, but the patentee has the option of offering the product or service at a lower price, for example to gain market share, or to match the pricing of competitors and enjoy a higher profit than the competition.

Businesses may face a challenge in making decisions regarding licensing patents to direct competitors or enforcing (or asserting) patents against alleged infringers. Licensing and enforcement decisions are often complex and may require assessment of numerous interrelated factors, such as, for example, value of the patents to the business, effect on market share, and the like. Conventionally, these decisions may be made using simple financial models that may rely on instinct or intuition rather than facts, data and sophisticated modeling tools.

Methods have been developed for new product introduction. For example, U.S. Pat. No. 6,859,782 (the '782 patent) describes a method for developing new products for introduction into the marketplace. The '782 patent describes a method whereby pools of new product concepts are provided, and a concept is selected from each pool for further development. A selected concept is engineered to optimize its intended utility function and a degree of proprietary protection is acquired for the selected concept. After proprietary protection is obtained, the selected concept is marketed to potential manufacturers for the purpose of obtaining a license and receiving royalty revenue from the licensee.

Although the method of the '782 patent may help in selecting new product concepts to develop and introduce into the marketplace, it may do little to provide a tool for analysis of products with protected features already in the marketplace. In particular, even though the '782 method may use a conjoint survey to select a new product concept from a pool of concepts to develop, it may be inapplicable to an identification of existing protected features and an analysis of the effects of introducing additional products with protected features into the marketplace.

Further, the method of the '782 patent may lack the analytical functions needed for making enforcement decisions regarding protected product features already present in the marketplace. In particular, the method of the '782 patent relates to new product concept selection for the purposes of product development, protection, and licensing. The method of the '782 patent may be inapplicable to analysis of the effects of removing existing products from the marketplace and predicting the value of enforcing a patent against an alleged infringer.

The disclosed system and method are directed to overcoming one or more of the problems set forth above.

### SUMMARY OF THE INVENTION

In one aspect, the present disclosure is directed to a conjoint method for making decisions relating to a patent. The method may include identifying at least one feature protected by at least one patent within a patent portfolio and generalizing each identified feature into a one or more corresponding attributes. The method may also include administering a conjoint survey including the one or more corresponding attributes and obtaining preference data from results of the conjoint survey. The method may further include determining whether to take action with respect to a patent in the portfolio based on the preference data.

In another aspect, the present disclosure is directed to a decision support system. The system may include a console, at least one input device, and a processing unit. The processing unit may be configured to identify at least one feature protected by at least one patent within a patent portfolio and generalize each identified feature into one or more corresponding attributes. The processing unit may be configured to administer a conjoint survey including the one or more corresponding attributes. The processing unit may also be configured to obtain preference data from results of the conjoint survey and to determine whether to take action with respect to a patent in the patent portfolio based on the preference data.

In another aspect, the present disclosure is directed to a method of providing consulting services to a party regarding intellectual property decision making. The method may include identifying at least one feature protected by at least one patent within a patent portfolio of interest to the party and generalizing the at least one identified feature into one or more corresponding attributes. The method may also include administering a conjoint survey including the one or more corresponding attributes and obtaining preference data from results of the conjoint survey. Further, the method may include determining whether to take action with respect to a patent in the patent portfolio based on the preference data and providing a result to the party of whether to take action with respect to the patent.

### BRIEF DESCRIPTION OF THE DRAWINGS

FIG. 1 provides a block diagram representation of an exemplary embodiment of a disclosed computer system for executing a conjoint method of making decisions regarding patent enforcement and patent licensing, in accordance with a presently disclosed embodiment;

FIG. 2 provides a flowchart illustration of an exemplary disclosed method of creating and administering a conjoint survey for making decisions regarding patent assertion and patent licensing;

FIG. 3 provides a flowchart illustration of an exemplary disclosed method for using conjoint survey results to make decisions regarding patent licensing; and

FIG. 4 provides a flowchart illustration of an exemplary disclosed method for using conjoint survey results to make decisions regarding patent assertion.

### DETAILED DESCRIPTION

Decisions regarding potential license deals with competitors or potential lawsuits to enforce patents can be aided by the application of a modeling tool called conjoint analysis. Conjoint analysis allows a patent owner to collect information about buyers' preferences for various combinations of brand, product or service features/attributes, and pricing. This information can be used in a conjoint modeling tool to run computer simulations of markets for various product and service offerings by the patent owner and competitors. The simulation results may indicate a “preference share” for each product or service on the market. For purposes of this disclosure, preference share is a market share projection, or the like. Although typical conjoint analysis may not make a direct link between market share and preference share, for purposes of this disclosure such a link may be inferred because the change of preference share may be of interest rather than an absolute value. In other words, for purposes of this disclosure it may be useful to use conjoint analysis to determine a change direction and relative change in preference share percentage that may occur from an action, even though the preference share and market share percentage values may not match. The simulation can also report sensitivity to changes in each of the attributes of the products and services offered by anyone in the market. Finally, the simulation may project the purchase likelihood for each simulated product.

As will be apparent, conjoint analysis provides a tool for assessing the expected effect on market share when new products are introduced into an existing market. Licensing patents to a competitor or allowing a competitor to allegedly infringe patents essentially results in the introduction of a new, competing product on the market. For example, a licensee may introduce a product having a protected feature licensed from the patentee, or an alleged infringer may already be selling a product that includes one of the patentee's protected features. Conjoint analysis can be used to forecast the effect on a patentee's market share if it licenses its patents to a competitor or the effect of not enforcing patents against an allegedly infringing competitor. The conjoint analysis may be used to simulate the entrance of these new products, as well as the effect on market share if an allegedly infringing product is removed from the market through a lawsuit or other enforcement of patent rights. The conjoint analysis may also be used to predict a change in price as a result of licensing, settlement, or other outcome from a licensing or enforcement action.

The conjoint analysis may allow attributes, for example price, brand, availability of certain product features, etc., of competing products to be changed within the simulation. Thus, simulations of product feature copying as well as any price erosion or loss of margin that may occur from alleged infringement of patents are possible. In this regard, it is useful to note that conjoint analysis may also be used for other types of intellectual property rights including those associated with trademarks, copyrights, trade secrets and other types of confidential information. The primary focus of the exemplary embodiments described below, however, is in assessing patent decisions.

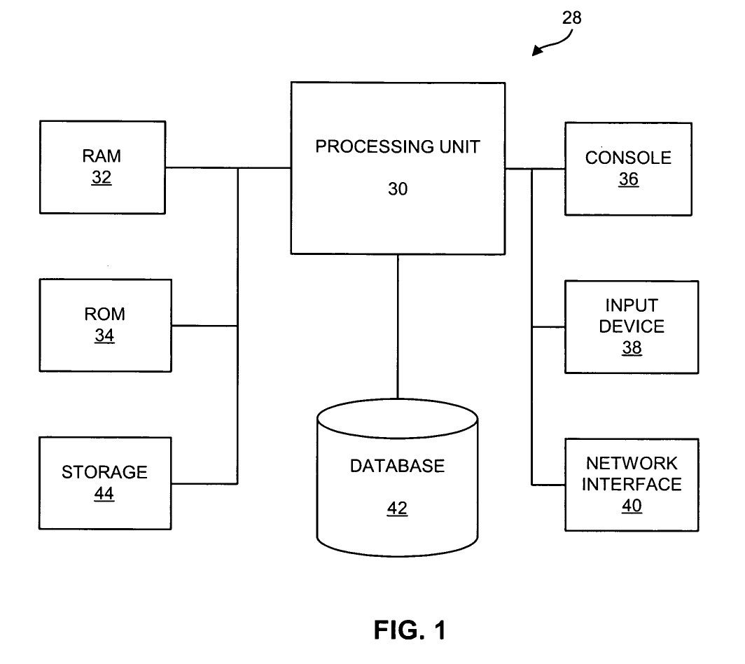

FIG. 1 provides a block diagram representation of computer system 28 for making decisions regarding patent assertion and patent licensing. For the purposes of this disclosure, patent licensing may be related to licensing one or more patents and may include such factors as royalty rate, pricing, scope of license, or others similar factors. For the purposes of this disclosure, the scope of a license may include such factors as patents covered by the license, geographic regions, duration, field of use, or other factors relating to the scope of a license. Computer system 28 may include central/distributed processing unit (CPU) 30, random access memory (RAM) 32, read-only memory (ROM) 34, console 36, input device 38, network interface 40, at least one database 42, and storage 44. It is contemplated that computer system 28 may include additional, fewer, and/or different components than those listed above. It is understood that the type and number of listed devices are exemplary only and not intended to be limiting.

CPU 30 may execute sequences of computer program instructions to perform various processes that will be explained below. CPU 30 may be a single processing unit or may be a distributed processing unit, such as, for example, a processing unit operating across a plurality of devices connected by a network or bus. The computer program instructions, for example, may be loaded into RAM 32 for execution by CPU 30 from ROM 34. The computer program instructions may also be distributed according to a contemplated architecture of CPU 30.

Storage 44 may be any appropriate type of mass storage provided to store information that CPU 30 may need to perform a process. For example, storage 44 may include one or more hard disk devices, optical disk devices, magnetic based devices, or other storage devices to provide storage space.

Computer system 28 may interface with a user via console 36, input device 38, and network interface 40. In particular, console 36 may provide a graphical user interface (GUI) to display information to users of computer system 28. Console 36 may include any appropriate type of computer display device or computer monitor. Input device 38 may be provided for users to input information into computer system 28. Input device 38 may include, for example, a keyboard, a mouse, or other optical or wireless computer input device. Further, network interface 40 may provide communication connections such that computer system 28 may be accessed remotely through computer networks. It should be appreciated that one or more elements of computer system 28, including software, may be distributed. For example, a conjoint survey may be given to participants over the Internet using a client/server architecture, or other distributed application architecture, while the conjoint analysis simulation may be executed on a desktop or laptop computer using the survey resulted received from the Internet participants.

Database 42 may contain patent data, product data, survey data, and other information related to data records under analysis. Database 42 may also include analysis tools for analyzing the information within database 42 and simulation tools for simulating patent licensing and assertion scenarios based on the information within database 42. CPU 30 may use database 42 to evaluate a patent portfolio and execute the disclosed conjoint method for making decisions regarding patent assertion and patent licensing.

For purposes of this disclosure, conjoint analysis refers to a broad range of market research, survey and analysis techniques for, among other things, assessing a value associated with the attributes or features of products and services. Conjoint analysis may include one or more forms such as, for example, discrete choice, choice-based modeling, hierarchical choice, card sorts, trade-off matrices, preference-based conjoint, pairwise comparisons, and other similar methods.

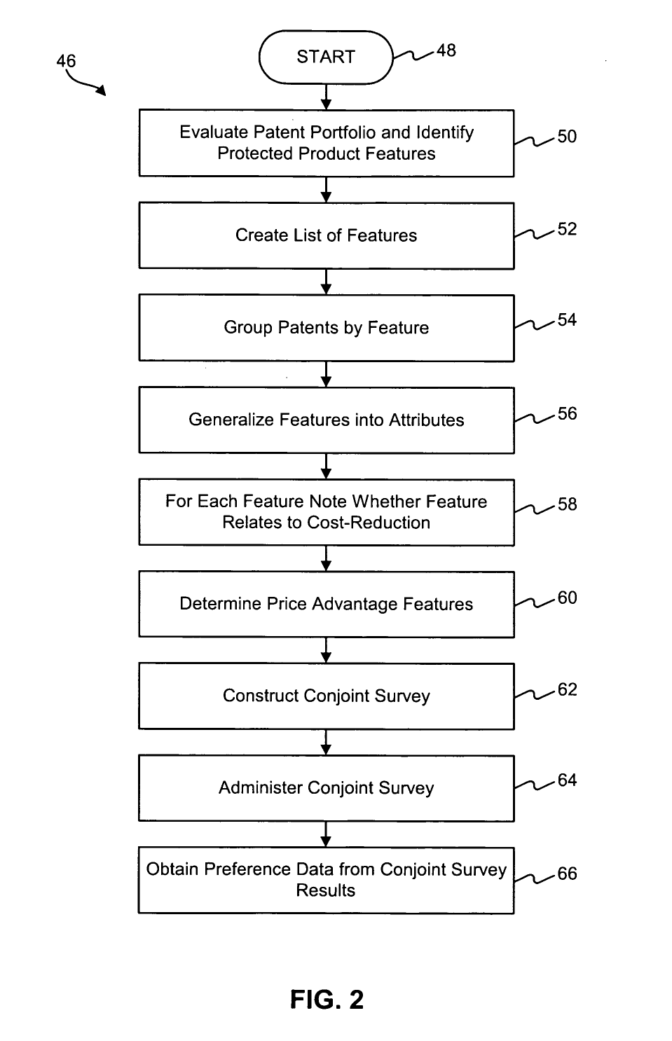

FIG. 2 illustrates a flowchart 46 depicting an exemplary embodiment of a method to construct and administer conjoint surveys to make decisions regarding patent assertion and patent licensing. The method illustrated by flowchart 46 may be performed, for example, by computer system 28, or any other automatic or manual system suitable for performing the method. As shown in FIG. 2, the first step after start (step 48) of the method may include evaluating a patent portfolio and identifying protected product features (step 50). For purposes of this disclosure, a patent portfolio may include one or more patents, patent applications, other intellectual property assets, or combination of the above. The evaluation of the patent portfolio may include assessing and identifying generalized product or service features that are protected by the patents in the patent portfolio. A list of the protected features may be created (step 52), and patents in the portfolio may be grouped according to these features (step 54). In addition, features not protected by the patent portfolio, and other features, such as, for example, brand and price may be identified for inclusion into a feature list for use in conjoint analysis.

Once identified, these features may be generalized into one or more corresponding attributes that can be described in relatively simple terms that make sense in the context of attributes of all relevant competing products (step 56). For purposes of this disclosure, features may include a claim element, a claim, a group of claims, or a combination of the above. For purposes of this disclosure, generalizing features into attributes means describing a feature in context of a product or in language suitable for a survey participant. In other words, features may be identifiable to the patentee and attributes may be representations of features identifiable to survey participants. The attributes may be readily understandable such that completion of a conjoint survey does not become too burdensome. If some patents relate to cost-reduction inventions in addition to product features, this should also be noted for later use in the conjoint analysis (step 58). As mentioned above, after assessment of the patent portfolio, the patents may be grouped by the product feature/attribute they protect and a list of product features/attributes may be created for which the patentee can obtain exclusivity through enforcement of the patents. Further, protected features that may allow the patentee to maintain a pricing advantage may be identified (step 60).

By identifying cost-reduction and price advantage protected features (steps 58 and 60), those protected features may be grouped separately from protected features providing product differentiation. This distinction in feature type may be useful when constructing an analysis or simulation based on the conjoint survey data. For example, by identifying and separating the price/cost advantage features from the product differentiation features, a conjoint analysis simulation may be constructed to focus on cost in the case of price/cost advantage features, or to focus on product features in the case of product differentiation protected features. The grouping of protected features by cost advantage or differentiation may allow for a more relevant conjoint analysis simulation to be constructed that may produce more accurate preference share data.

A conjoint survey is constructed according to one or more of the attributes identified (step 62). In particular, the conjoint survey utilizes a set of product or service attributes with a series of potential attribute categories for each attribute. The attributes may include brand/manufacturer, price, and presence/absence of the patented features determined in the portfolio analysis. These categories preferably should not overlap and preferably they should not include ranges. A conjoint survey may be constructed in one of several forms, for example, a common form of survey is an adaptive conjoint analysis (ACA) survey that uses adaptive survey software to test respondents' preference for various combinations of product attributes. Further, regional-based conjoint surveys may need to be constructed. For example, a regional-based survey may need to be constructed depending on similarities or differences in cultural, societal, or political climate of each region where survey data may be desired. A region may represent a portion of a country, an entire country, a portion of a continent, an entire continent, a group of countries, or a group of continents. A region may also represent one or more identifying characteristics, such as, for example, geographical, political, cultural, societal, or other characteristics, of a group for which conjoint survey participation may be desired.

Once constructed, the conjoint survey may be administered to a group of actual or representative purchasers of the products or services (step 64). For example, a relatively small (for example 25-50) group of actual purchasers of the products being studied may be given the survey. In one embodiment, an ACA survey may be administered. As an alternative to an ACA survey, a choice-based conjoint (CBC) survey or a conjoint value analysis (CVA) survey can be used. These examples of different conjoint analysis and survey methods are provided for illustration purposes only and are not intended to be limiting. Other types of conjoint analysis, now known or later developed, that would perform similar functions to those described above may be used. The respondent can be encouraged to participate through various means, including payment of a fee for participation or offering another suitable incentive, such as a gift certificate. Preference data may be obtained from the conjoint survey results (step 66).

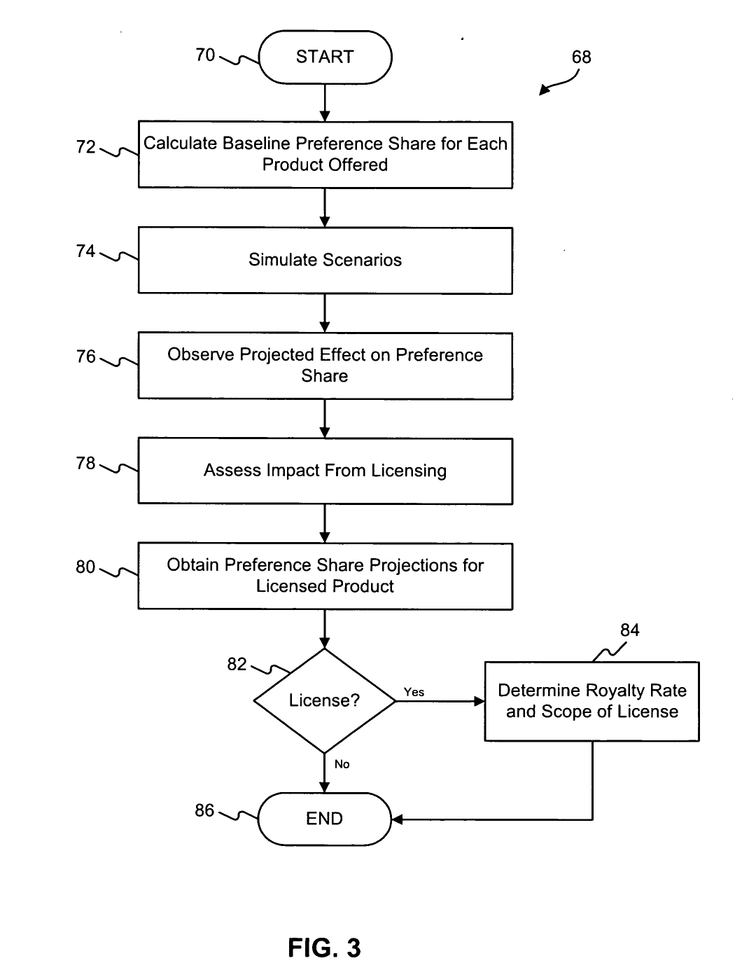

FIG. 3 illustrates a flowchart 68 depicting an exemplary embodiment of a method of using preference data obtained from the conjoint survey results to make decisions regarding patent licensing. In particular, the results of the conjoint survey can provide preference data that may be used in a simulation package such as, for example, SMRT software (presently available from Sawtooth Software, Inc., of Sequim, Wash.).

As shown in FIG. 3, the first step after start (step 70) of the method may include calculating a baseline preference share for some or all of the products or services currently offered in the market using the preference data and the simulation package (step 72). The products or services offered in the market may include products made by or associated with a patentee or with a patent licensee. The products or services in the market may also include other products of interest for which a baseline preference share may be calculated. Actual market share data, if available, may be used to assess a correlation between baseline preference share and market share. It should be noted that in certain embodiments, the calculated baseline preference share may include or may be substituted for actual market share data.

With the baseline preference share calculation completed, the patent owner can simulate various scenarios related to patent licensing (step 74). These scenarios each may include a change with respect to the market conditions for which the baseline preference data were determined. For example, the patent owner may wish to observe the effects on preference share caused by adding to the market one or more target products (e.g., products for which a license under the patent owner's patent(s) may be appropriate). The patent owner may also wish to observe the effects on preference share caused by removing from the market one or more other target products. A particular scenario may include any combination of adding or removing any number of target products to the market. Each target product in a scenario may include none, some, or all of the patented features of the patent owner's patents.

A simulation can be run to determine projected preference shares for the products in the market along with the one or more target products added to the market. The patentee can then observe the projected effect on preference shares caused by the addition of the one or more target products (step 76). This information can be used to assess the impact on profit from licensing the patents (step 78). The decision with respect to licensing of the patent may be based on the projected preference shares (e.g., the projected preference shares may constitute at least one factor considered during the licensing decision). For example, the decision may be based on an observed difference between the baseline preference shares and the projected preference shares.

The simulations can provide the patent owner with preference share projections for the new, licensed product (e.g., the target product(s)) (step 80). These preference share projections may then be used to predict licensing revenue and make a decision whether or not to license a patent (step 82). The conjoint analysis can be used to test the effect of changes, such as, for example, changes in royalty rates, changes in pricing, and even changes in the scope of the licenses granted (e.g. which patents, which regions, which fields of use, and the like). If a decision to license has been made, then the preference share projections may be used as a guide in determining royalty rate and scope of license (step 84) and the method ends (step 86). If a decision not to license has been made, then the method ends (step 86). The disclosed method may be performed automatically, manually or by a combination of the above.

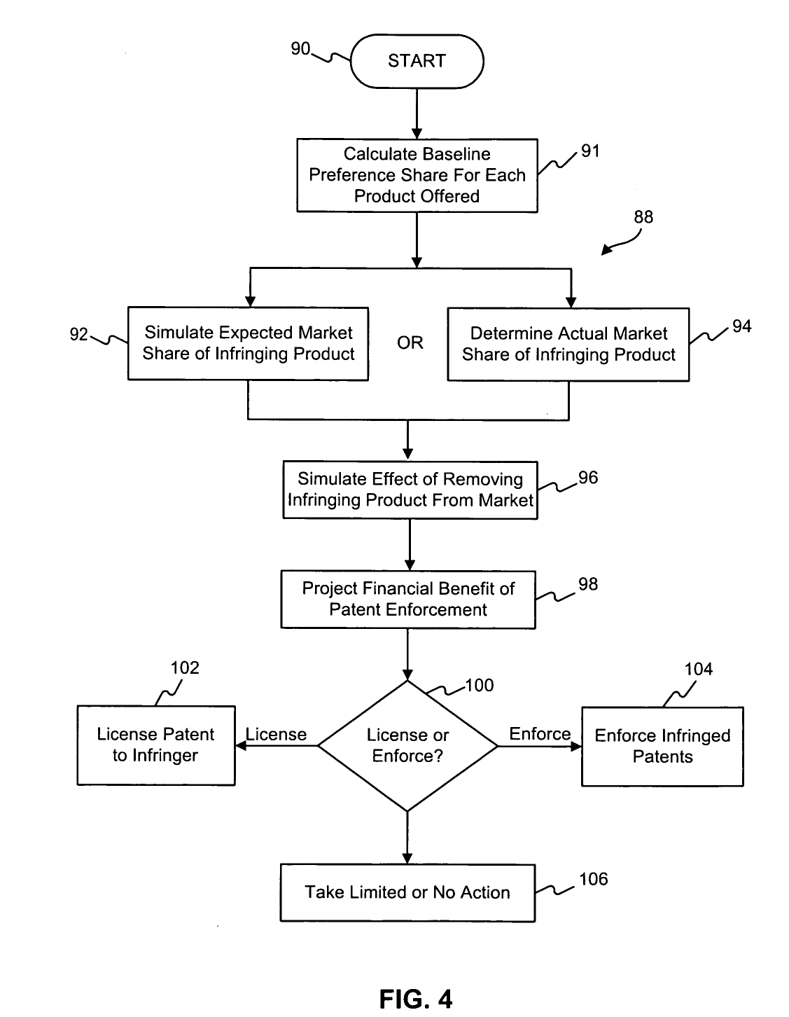

FIG. 4 illustrates a flowchart 88 depicting an exemplary embodiment of a method for making decisions regarding patent enforcement. As shown in FIG. 4, the first step after start (step 90) of the method may include calculating a baseline preference share for products or services currently offered in the market using the preference data and the simulation package (step 91). It should be noted that the baseline preference share may be determined for all of the products in a particular market or, alternatively, only a subset of the products in the market. Next, the market share of an allegedly infringing product is determined or estimated. In certain embodiments, the market share of the allegedly infringing product will be included in the determination of the baseline preference share for products on the market (e.g., where the allegedly infringing product is already part of the market of interest). Thus, the preference share data for the allegedly infringing product may be determined along with or separate from the determination of the baseline preference share data for market products. The expected market share of an allegedly infringing product or service may be estimated through simulation of expected market share (step 92). Alternatively, actual market share of the allegedly infringing product may be determined (step 94). Once the market share of the allegedly infringing product has been determined or estimated, simulation software may be used to simulate the effect of removing the allegedly infringing product from the market though a lawsuit or other enforcement (step 96). The simulation software may also be used to simulate an increase in price as a result of licensing, or to simulate the effect of a cross-license.

Comparing the projected preference share of market products to the baseline preference share for those products, including the allegedly infringing target product(s), may provide information regarding the effects on the products of various entities as a result of removal from the market of the allegedly infringing product. For example, not only can this analysis project the effects on the preference share of the patent owner's products and the preference share of the target product(s), but information relating to the preference share of other products made by other competitors, for example, may also be determined.

The decision of whether to enforce a patent can be based on the projected preference share information. As with the licensing scenario discussed above, the enforcement decision can be based in whole or just in part on the projected preference share information. Other factors may also affect the enforcement decision.

The market share, or preference share, information of the patent owner's product and the allegedly infringing product allows calculation of a projected financial benefit from patent enforcement (step 98). The projected financial benefit may allow the patent owner to decide whether to invest in the cost of a lawsuit or other enforcement measure to stop the alleged infringing activity (step 100). If a decision is made not to enforce an allegedly infringed patent, then, as an alternative to enforcement, the patent may be licensed (step 102). If a decision is made to enforce, then any allegedly infringed patents may be enforced (step 104). In another alternative, the simulation may reveal that the allegedly infringing activity does not justify the cost of enforcement, and, accordingly, limited or no assertion or enforcement action may be taken (step 106). Limited action may include, for example, a letter informing a possible infringer of the existence of one or more intellectual property assets. The disclosed method may be performed automatically, manually or by a combination of the above.

Preference share data from a conjoint analysis may be used as described above in relation to FIGS. 3 and 4 to build a business case (business model) for making a decision regarding intellectual property assets, and in particular patents. The conjoint preference share data may be used to forecast revenue and earnings for the various licensing, acquisition, or enforcement scenarios that may be simulated in conjoint analysis simulation software. For example, a forecast may be created in a spreadsheet software package, such as, for example, Microsoft Excel, which is a commercially available off-the-shelf software package produced by Microsoft Corporation. A financial simulation package or software add-on module may also be used where a need may exist for a more advanced financial simulation or forecast. For example, an add-on to Excel, or a dedicated software tool, may be used to run a Monte Carlo simulation, or the like. An example of a suitable add-on package for Excel may be Crystal Ball (presently available from Decisioneering, Denver, Colo.), which may allows designation of certain cells in a spreadsheet as being a variable that follows from statistical distribution (e.g. normal, Poisson, binomial, etc.). A particular statistical method may be selected based on one or more variables. The Monte Carlo software may run a number of simulations, for example hundreds, in Excel taking variable data from the statistical distributions and reports and probable outcome based on the simulations. Distribution and sensitivity reports may also be generated. Thus, a first simulation may be used to get preference share data, which may be a market share predictor, then a second simulation may be used in the business case to account for variance in the data. Items having variance in the business case may include royalty rate, sales volume, sales growth rate, market size, market growth rate, pricing, product cost, fixed/period costs, litigation costs, and likelihood of success in litigation, and the like.

### INDUSTRIAL APPLICABILITY

The disclosed system and method may be used to make licensing and enforcement decisions regarding intellectual property using conjoint analysis. Conjoint analysis can be used to decide whether to offer licenses to alleged infringers or to enforce patents or other intellectual property assets, because conjoint analysis results may be used to simulate relevant scenarios of market share effect which can be used to determine a financial impact associated with each option.

In particular, the disclosed system and method may be used to estimate, or forecast, a market share effect of licensing or enforcing a patent and a financial impact associated with any licensing or enforcement. The estimated market share effect may then be used in a financial model to analyze a financial impact of prospective licensing or enforcement of the patent. With the benefit of the financial impact analysis, a decision regarding licensing or enforcement of the patent may be made.

The disclosed system and method may also be used to make proactive or reactive licensing decisions. For example, a patent owner may identify a patent, or other intellectual property asset, that potentially covers a product or service being offered by a competitor. The method of the presently disclosed system may be used to simulate and forecast a market share impact and a financial impact of proactively licensing the patent to the competitor. Similarly, a competitor of the patent owner may identify its own patent, or other intellectual property asset, that potentially covers one or more products of the patent owner. In this scenario, the presently disclosed system may be used to simulate and forecast a market share impact and a financial impact of reactively obtaining a license for the competitor's patent. A decision to initiate, or enter into, licensing discussions may be based on the financial impact or market share impact. The disclosed system and method may also be offered as a consulting service by a third party to an intellectual property owner or other party with an interest in an intellectual property asset. The disclosed system and method may also be used by a mediator, arbitrator or the like as an aid to resolving a dispute regarding an intellectual property asset by providing data that may be useful for analyzing the future impact of decisions each party may make.

Further, the disclosed system and method may be applicable to making acquisition decisions (licensing or purchase) of an intellectual property asset. For example, the conjoint method may be applicable to responding to licensing inquiries from an owner of a patent offering to license or sell the patent. Through the system and method of the present invention, preference share data and purchase decision driver data may be obtained. The preference share data and purchase decision driver data may be used to formulate a business case regarding whether to acquire a right, for example through licensing or purchase, in the patent or other intellectual property asset being offered.

The disclosed system and method may identify protected features within a patent portfolio and, using conjoint analysis techniques to obtain share preference data, may simulate the effects of introducing additional products with protected features into the marketplace.

Further, the disclosed method provides an analytical tool for making enforcement decisions regarding protected product features already present in the marketplace. In particular, the disclosed method can provide an assessment of the effect of removing existing products in the marketplace and predicting the value of enforcing a patent against an alleged infringer. The disclosed method may also provide a prediction of price or market share changes as a result of licensing, cross-licensing, and/or settlement of an enforcement action.

It will be apparent to those skilled in the art that various modifications and variations can be made to the methods and systems of the present disclosure. Other embodiments of the methods and systems will be apparent to those skilled in the art from consideration of the specification and practice of the methods and systems disclosed herein. It is intended that the specification and examples be considered as exemplary only, with a true scope of the disclosure being indicated by the following claims and their equivalents.

What is claimed is:

1. A method for making decisions relating to a patent, the method comprising:
identifying at least one feature protected by at least one patent within a patent portfolio;
generalizing the at least one identified feature into one or more corresponding attributes;
administering a conjoint survey including the one or more corresponding attributes;
obtaining preference data from results of the conjoint survey; and
determining whether to take action with respect to a patent in the patent portfolio based on the preference data.

2. The method of claim 1, wherein determining whether to take action with respect to the patent includes determining whether to license the patent.

3. The method of claim 2, wherein determining whether to license the patent includes:
calculating baseline preference shares for products in a market;
creating a scenario that includes an addition to the market of at least one target product;
running a simulation of the scenario to determine projected preference shares for the products in the market and the at least one target product; and
determining whether to license the patent based on the projected preference shares.

4. The method of claim 3, wherein determining whether to license the patent based on the projected preference shares includes observing a difference between the baseline preference shares and the projected preference shares.

5. The method of claim 3, wherein determining whether to license the patent based on the projected preference shares includes using the projected preference shares to assess a projected effect on profit.

6. The method of claim 1, wherein determining whether to take action with respect to the patent includes determining whether to enforce the patent.

7. The method of claim 6, wherein determining whether to enforce the patent includes:
calculating baseline preference shares for products in a market;
creating a scenario that includes a subtraction from the market of at least one target product;
running a simulation of the scenario to determine projected preference shares for the products remaining in the market after the subtraction of the at least one target product; and
determining whether to enforce the patent based on the projected preference shares.

8. The method of claim 7, wherein determining whether to enforce the patent based on the projected preference shares includes observing a difference between the baseline preference shares and the projected preference shares.

9. The method of claim 7, wherein determining whether to enforce the patent based on the projected preference shares includes using the projected preference shares to assess a projected effect on profit.

10. The method of claim 6, further including determining whether to license the patent if a determination is made not to enforce the patent.

11. The method of claim 1, further including grouping patents in the patent portfolio according to the at least one protected feature.

12. The method of claim 1, further including identifying any protected feature that relates to cost reduction of a product or service.

13. The method of claim 1, further including determining whether each protected feature provides a price advantage to a product or service.

14. The method of claim 1, wherein the conjoint survey includes an adaptive conjoint survey.

15. The method of claim 1, wherein the conjoint survey includes a choice-based conjoint survey.

16. The method of claim 1, wherein the administration of the survey includes offering an incentive for a person to participate in the survey.

17. A decision support system, comprising:
a console;
at least one input device; and
a processing unit configured to:
identify at least one feature protected by at least one patent within a patent portfolio;
generalize the at least one identified feature into one or more corresponding attributes;
administer a conjoint survey including the one or more corresponding attributes;
obtain preference data from results of the conjoint survey; and
determine whether to take action with respect to a patent in the patent portfolio based on the preference data.

18. The decision support system of claim 17, wherein the processing unit is distributed.

19. The decision support system of claim 17, wherein the processing unit is further configured to determine each protected feature that provides a price advantage to a product or service.

20. The decision support system of claim 17, wherein the conjoint survey includes an adaptive conjoint survey.

21. The decision support system of claim 17, wherein the conjoint survey includes a choice-based conjoint survey.

22. The decision support system of claim 17, wherein the action includes licensing of the patent.

23. The decision support system of claim 22, wherein the processing unit is further configured to:
calculate baseline preference shares for products in a market;
run a simulation of a scenario, which includes an addition to the market of at least one target product, to determine projected preference shares for the products in the market and the at least one target product; and
determine whether to license the patent based on a difference between the projected preference shares and the baseline preference shares.

24. The decision support system of claim 23, wherein the processing unit is further configured to use the projected preference shares to assess a projected effect on profit.

25. The decision support system of claim 17, wherein the action includes enforcement of the patent.

26. The decision support system of claim 25, wherein the processing unit is further configured to:
calculate baseline preference shares for products in a market;
run a simulation of a scenario, which includes a subtraction from the market of at least one target product, to determine projected preference shares for the products remaining in the market after the subtraction of the at least one target product; and
determine whether to enforce the patent based on a difference between the projected preference shares and the baseline preference shares.

27. The decision support system of claim 26, wherein the processing unit is further configured to use the projected preference shares to assess a projected effect on profit.

28. A method of providing consulting services to a party regarding intellectual property decision making, the method comprising:
identifying at least one feature protected by at least one patent within a patent portfolio of interest to the party;
generalizing the at least one identified feature into one or more corresponding attributes;
administering a conjoint survey including the one or more corresponding attributes;
obtaining preference data from results of the conjoint survey;
determining whether to take action with respect to a patent in the patent portfolio based on the preference data; and
providing a result to the party of whether to take action with respect to the patent.

29. The method of claim 28, wherein determining whether to take action includes determining whether to enforce a patent in the patent portfolio.

30. The method of claim 29, wherein determining whether to enforce the patent includes:
calculating baseline preference shares for products in a market;
creating a scenario that includes a subtraction from the market of at least one target product;
running a simulation of the scenario to determine projected preference shares for the products remaining in the market after the subtraction of the at least one target product; and
determining whether to enforce the patent based on a difference between the projected preference shares and the baseline preference shares.

31. The method of claim 30, further including using the projected preference shares to assess a projected effect on profit.

32. The method of claim 28, wherein determining whether to take action includes determining whether to license a patent in the patent portfolio.

33. The method of claim 32, wherein determining whether to license the patent includes:
calculating baseline preference shares for products in a market;
creating a scenario that includes an addition to the market of at least one target product;
running a simulation of the scenario to determine projected preference shares for the products in the market and the at least one target product; and
determining whether to license the patent based on a difference between the projected preference shares and the baseline preference shares.

34. The method of claim 33, further including using the projected preference shares to assess a projected effect on profit.

35. The method of claim 28, wherein the method further includes identifying any protected feature that relates to cost reduction of a product or service.

36. The method of claim 28, wherein the method further includes determining each protected feature that provides a price advantage to a product or service.

37. A method for making patent acquisition decisions, the method comprising:
identifying at least one feature protected by at least one patent within a patent portfolio;
generalizing the at least one identified feature into one or more corresponding attributes;
administering a conjoint survey including the corresponding attributes;
obtaining preference data from results of the conjoint survey; and
determining whether to acquire a right in a patent in the patent portfolio based on the preference data.

38. A method for making decisions relating to intellectual property assets, the method comprising:
identifying at least one feature protected by at least one intellectual property asset within an intellectual property portfolio;
generalizing the at least one identified feature into one or more corresponding attributes;
administering a conjoint survey including the corresponding attributes;
obtaining preference data from results of the conjoint survey; and
determining whether take action with respect to an intellectual property asset in the intellectual property portfolio based on the preference data.
